(19) United States
(12) Patent Application Publication
(10) Pub. No.: US 2013/0298432 A1
(43) Pub. Date: Nov. 14, 2013

(54) AUTOMATED ROTATING BILLBOARD

(71) Applicant: Glenn R. Gatuslao, Makati City (PH)

(72) Inventor: Glenn R. Gatuslao, Makati City (PH)

(21) Appl. No.: 13/982,250

(22) PCT Filed: Apr. 15, 2011
(86) PCT No.: PCT/PH2011/000005

§ 371 Date: Jul. 26, 2013

(30) Foreign Application Priority Data
Jan. 26, 2011 (PH) 2-2011-000032

(51) Int. Cl. G09F 7/22

(52) U.S. Cl. CPC G09F 7/22
USPC 40/473

(57) ABSTRACT

This disclosure pertains to the outdoor advertising medium, specifically the automated rotating billboard. Further, this is an enhancement of the current structure. Such an Improved Automated Rotating Billboard (31) maintains the three basic parts of the existing structure. One, the billboard frame which has the lighting facility consisting of a plurality of lighting fixtures, but now using the LED lights. Second, the upstanding post comprises the upper rotating post member and the lower stationary post member. The improved structure has enhanced features namely, the frequency inverter; the increased load capacity of the rotating disc; the amplified capacity of the carbon brush; and the default mechanism of the rotating disc. Moreover, both width and height measurements of the upstanding post are ensured to guarantee safety. Third, the pedestal is made stronger to support the entire structure. Indeed, this improved model offers a much more efficient outdoor advertising exposure.

### FIELD OF THE UTILITY MODEL

This utility model generally relates to the advertising medium, particularly referring to the Automated Rotating Billboard. This application is an enhancement of the existing structure of the abovementioned.

### BACKGROUND OF THE UTILITY MODEL

The existing Automated Rotating Billboard which obtains an IPOPhil registration no. 2-2008-000534 and a PCT registration no. PCT/PH2009/000012, has its debut commercially and publicly for almost two (2) years now. The current structure comprises the billboard frame which may vary in height and width, however, the measurement is ensured to be within the legally permissible range, as may be identified by existing and succeeding national and city ordinances; the upstanding post which has the upper rotating post member and the lower stationary post member; and the pedestal. During the conduct of its standard operations, various technical concerns have been identified with and are appointed as good opportunities for noteworthy improvements. Thus, there are six (6) substantial areas of concern that require improvements.

First area of concern is the need to control speed of the rotation through the use of the Frequency Inverter. The existing automated rotating billboard has a rotation of about 40 seconds per rotation and the same structure does not bear a designated feature on its own which makes it possible for advertisers to easily adjust and tailor-fit the speed of the structure according to its desired rotation frequency.

Second area of concern focuses on the increased capacity of the carbon brush which is used for the transmission of electricity to any other parts of the structure to prevent any possible electrical failure. The existing structure has carbon brush with low capacity in terms of electrical transmission which results to a short circuit whenever the electrical requirement goes beyond the specified capacity. This can hereby cause explosion of the fuse and altogether cause stoppage of the entire rotating mechanism of the structure. With the increased capacity of carbon brush used, the electrical requirement to start the operations of the structure can now be satisfied with.

Meanwhile, considered as the third area of concern is the significant increase of the tonnage or load capacity of the rotating disc. The existing structure carries only up to ten (10) tons, which, if not increased, will be limiting the versatility of the automated rotating billboard. The improved version has a rotating disc which can hold up a Tri-vision and LED Board.

On the other hand, the fourth area of concern is the use of purely LED lights to provide the backlit requirements of the frame. The existing structure frame is lighted with a combination of 40-watt LED light and 80 sets of fluorescent lamps.

Further, a fifth area of concern is the width of the upstanding post which comprises both the upper rotating post member and the lower stationary post member. These two parts of the upstanding post hold up high the frame of the automated rotating billboard. Currently, the upstanding post has an upper rotating post member with a 20-inch diameter and a lower stationary post member with a 24-inch diameter. Having known and anticipated the endless possibilities of the creative billboard industry, it is essential that both the upper rotating post member and the lower stationary post member must not be limited to a single measurement only, but instead, both the upstanding post members must be measured up according to the measurement and load capacity of the billboard frame which is to be attached to the said post. It is intended to fully support any frame which may have faces or sides that are more than two. Likewise, it is seen to hold high any replica of a product sought to be advertised.

Lastly, the sixth area of concern is the height measurement of the upstanding post. The existing structure has a definitive measurement of about 14 feet high. In this improved version of the automated rotating billboard, said structure is expected to posses a height measurement ranging from a minimum 15 feet from the pedestal up to as high as 60 feet from the pedestal. It is important to note that one determining factor of the height of the upstanding post is the location where the automated rotating billboard is to be installed. There are various determinants as to the viability of installing the structure which need to be complied with. And all these requirements determine the appropriate height of the upstanding post.

### BRIEF DESCRIPTION OF THE SEVERAL VIEWS OF THE DRAWINGS

FIG. 1 is a perspective view of An Improved Automated Rotating Billboard with longitudinal rectangular billboard frame;

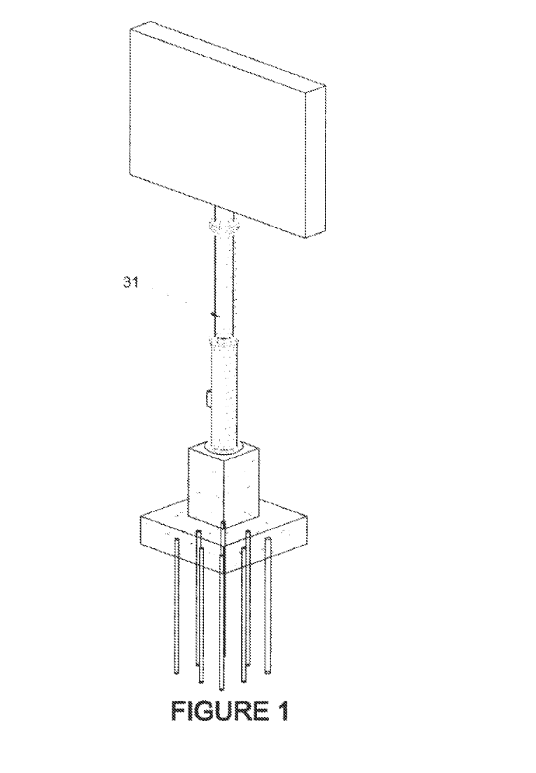

FIG. 2 is a partial exploded perspective view of the rotating mechanism thereof;

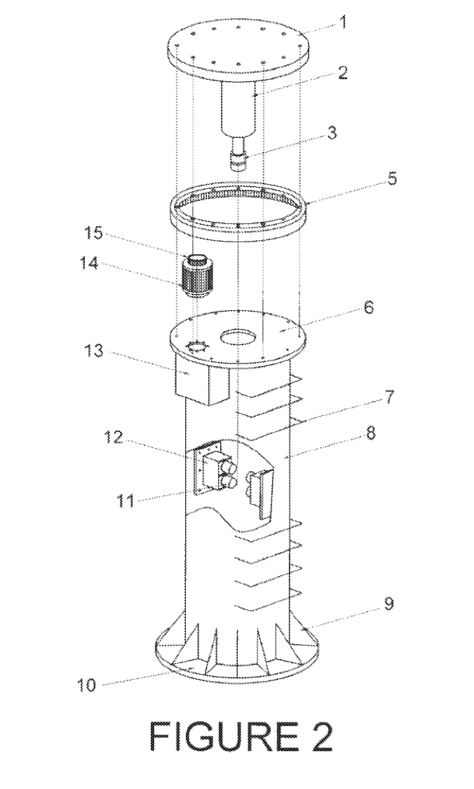

FIG. 3 is a partial exploded perspective view of the electrical control box or pedestal thereof;

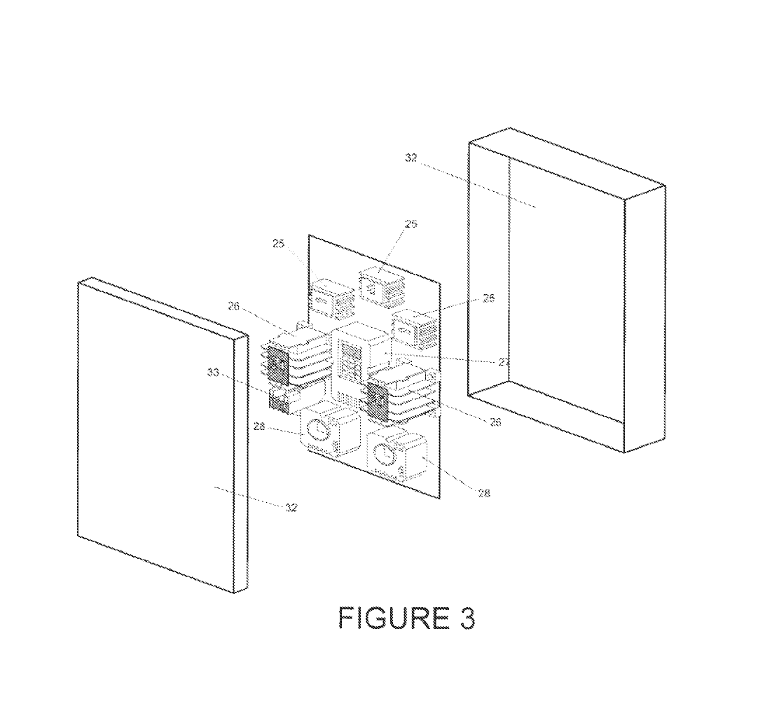

FIG. 4 is a partial exploded perspective view of the billboard frame thereof;

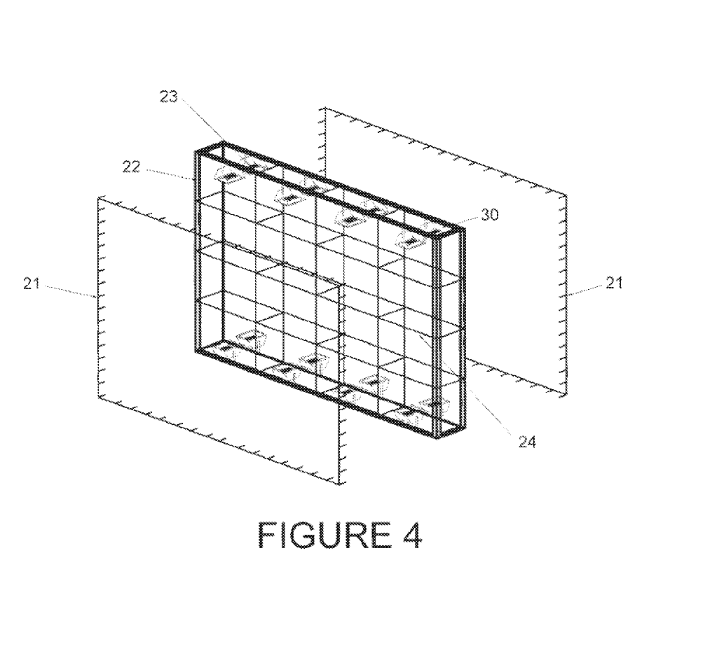

FIG. 5 is a partial sectional view of the interconnection of the upper and lower post members.

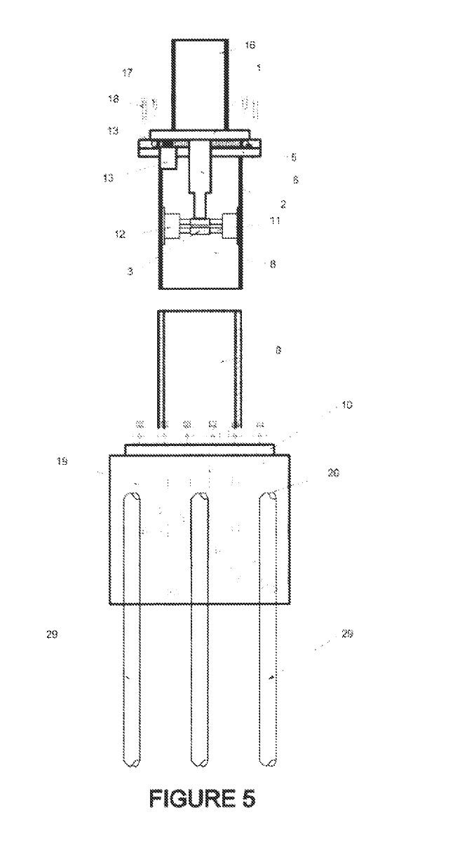

### DETAILED DESCRIPTION

Referring now to the several views of the drawings, wherein like reference numerals designate same parts throughout, there is shown a utility model for an Improved Automated Rotating Billboard generally designated as 31.

Said improved version of the previously registered utility model also comprises the same features such as the billboard frame 22, the upstanding post 16 & 8, and the pedestal 20. However, to efficiently make the most out of its features and functions, this improved utility model expands the capability of the features that are either present in the existing structure or if not yet, are substantially added to boost the potential of the outdoor advertising medium.

As regards the first area of concern which is to control the speed of rotation, a frequency inverter 27 was attached to the wirings of the gear motor 14. Said frequency inverter 27 is used to control the rotational speed of the gear motor 14 by controlling the frequency of the electrical power supply to the gear motor 14. The gear motor 14 is situated at the motor housing 13 and it has 2HP with 220 volts and it is 3-phase with built-in gear and has a ratio of 1:200. Said gear motor 14 is connected in series to an overload relay 33 which acts as a sensing element that can monitor current flow based on the current magnitude and duration. Its built-in mechanism inside can interrupt the flow when overload occurs. Thus, when a high wind velocity tries to oppose the rotation of the motor, the current required by the gear motor 14 increases and when it reaches above limit current capacity of the gear motor 14, overload occurs. Then, the overload relay 33 mechanism trips off and the supply on the motor is cut-off and enables the rota disc 5 to rotate in a free wheeling motion. Also, a pinion gear 15 is attached to the motor driving shaft 2 to create a rotary motion at the same time meshed to the spur gear 15. The said frequency inverter 27 is then attached by a wiring connection connected to the electrical control panel box 32 and at the same time extending a wire connection from the frequency inverter 27 to the said gear motor 14 thus providing a control on the frequency and torque by the said gear motor 14 which results on the varying speed of the rotary motion.

To remedy the problem of having frequent short circuits while the structure operates, this improved utility model is built with an amplified capacity of the carbon brush 11 bearing 3000 watts and which can be maximized up to 5000-7000 watts for LED purposes. Said carbon brush 11 is used to conduct electricity from the source to the lights attached to the upper rotating post member 16. The increased capacity carbon brushes 11 were attached to its respective carbon brush holders 12 to hold the said brushes in place and to avoid contact with the steel post which initializes short circuit breakdown. The said holders were aligned to fit in full contact with the said slip ring 3 to permit the flow of electricity to provide illumination.

Meanwhile, one of the significant breakthroughs of this improved automated rotating billboard is the bigger load capacity of its rotating disc. Also called as the slewing bearing 5 or turn table assembly, it consists of cylindrical roller bearings that can accommodate axial, radial ad moment loads acting either singly or in combination and in any direction bolted on the seating surface with hexagonal bolts 18. This disc has a load capacity of about 30 to 35 tons which is just as capable to hold heavier billboard frames such as Tri-vision and LED Board. Same tonnage is used for backhoe or crane with sizes ranging from 36″ to 48″ diameter. The hexagonal bolt 18 that is Grade A36 steel is used to mount the mounting plate of the rotating disc 5.

On the other hand, the fourth area of concern which is the use of purely LED lights. Said 50 watts LED lights 23 which were made up of die cast aluminium housing 30 and water resistant were attached in between the frames of the said billboard structure by bolting with the use 10 mmø grade A-36 steel bolt and nut.

Furthermore, the fifth concern would be to give way to the versatility of the automated rotating billboard, the solution therefore is to guarantee that the upper rotating post member 16 and the lower stationary post member 8 should possess width measurement of at least 20-inch diameter for the upper rotating post member 16 and a 24-inch diameter for the lower stationary post member 8. These width measurements must be considered as the standard measurements respectively, and the same may be increased according to the load capacity requirements of the billboard frame 22.

Lastly, this improved utility model responds to the need for a more flexible structure particularly in its height requirement that is likewise dependent upon the location where the structure will be installed. The enhanced version shall have a minimum height of about 15 feet from the pedestal 20 up to as high as 60 feet from the pedestal 20. The abovementioned height range should correspond with the measurement and load capacity of the billboard frame 22 to assure safety of the structure. The anchor bolt 19 which is Grade A-36 steel, is used to connect the concrete pedestal 20 to the steel post 8. The said lower stationary post member 8 is attached to the concrete pedestal 20 by the use of Grade A-36 steel anchor bolt 19 connecting the base plate 10 of the lower stationary post member 8 and the concrete pedestal 20. Size of anchor bolts 19 varies from 25 mmø to 32 mmø in order to resist enough tension, bending and torque that the lower stationary post member 8 transmits to the concrete pedestal 20 down to the foundation. Said foundation is designed using 6″ ø G.I. pipes with inside concrete acting as piles 29 embedded 20′ to 30′ below the bottom of the footing to prevent any overturning condition that might occur due to large velocity winds during typhoon season, resulting in a typhoon resistant structure. The mounting plate 10 which is made of 30-40 mm thick that is MS plate with Grade A36. The base plate 10 which is made of 25-30 mm thick that is MS plate with Grade A36. And the stiffener plate 9 that is used to stiffen the post against buckling and which is 10-12 mm thick that is MS plate with Grade A36.

The foregoing description is provided for illustrative purposes only and should not be construed as in any way limiting this utility model, the scope of which is defined solely by the appended claims.

This improved automated rotating billboard shall retain the same basic features of the original automated rotating billboard, such as the billboard frame 22, the upstanding post which has the upper rotating post member 16 and the lower stationary post member 8, and the pedestal 20. However, particular features are added in order to construct a better and more efficient structure.

1: The improved automated rotating billboard as an outdoor advertising medium has a feature that can control the speed of rotation as may be desired by the its respective advertisers. The rotational speed control is made possible through the use of a frequency inverter 27. Said frequency inverter 27 is used to control the rotational speed of the gear motor 14 by controlling the frequency of the electrical power supply to the gear motor 14. The gear motor 14 is situated at the motor housing 13 and it has 2HP with 220 volts and it is 3-phase with built-in gear and has a ratio of 1:200. Also, a pinion gear 15 is attached to the motor driving shaft 2 to create a rotary motion at the same time meshed to the spur gear 15. The said frequency inverter 27 is then attached by a wiring connection connected to the electrical control panel box 32 and at the same time extending a wire connection from the frequency inverter 27 to the said gear motor 14 thus providing a control on the frequency and torque by the said gear motor w/c results on the varying speed of the rotary motion.

2: Default mechanism of the improved automated rotating billboard structure. This pertains to the gear motor 14 which is connected in series to an overload relay 33 which acts as a sensing element that can monitor current flow based on the current magnitude and duration. Its built-in mechanism inside can interrupt the flow when overload occurs. Thus, when a high wind velocity tries to oppose the rotation of the motor, the current required by the gear motor 14 increases and when it reaches above limit of the current capacity of the gear motor 14, overload occurs. Then, the overload relay 33 mechanism trips off and the supply on the motor is cut-off which enables the rota disc 5 to rotate in a free wheeling motion.

3: The increased capacity of the carbon brush 11 as electrical conductor in order to comply with the electrical requirements of the entire structure, thereby preventing any possible short circuit of the electrical parts. This improved utility model is built with an amplified capacity of the carbon brush 11 bearing 3000 watts and which can be maximized up to 5000-7000 watts for LED purposes. Said carbon brush 11 is used to conduct electricity from the source to the lights attached to the upper rotating post 16. The increased capacity carbon brushes 11 were attached to its respective carbon brush holders 12 to hold the said brushes in place and to avoid contact with the steel post which initializes short circuit breakdown. The said holders were aligned to fit in full contact with the said slip ring 3 to permit the flow of electricity to provide illumination.

4: The amplified tonnage capacity of the rotating disc 5 from 10 tons, now reaching as heavy as 30 to 35 tons which capacitates the disc to hold up a tri-vision and LED Board. Also called as the slewing bearing 5 or turn table assembly, it consists of cylindrical roller bearings that can accommodate axial, radial ad moment loads acting either singly or in combination and in any direction bolted on the seating surface with hexagonal bolts 18. This disc has a load capacity of about 30 to 35 tons which is just as capable to hold heavier billboard frames 22 such as Tri-vision and LED Board. Same tonnage is used for backhoe or crane with sizes ranging from 36″ to 48″ diameter. The hexagonal bolt 18 that is Grade A36 steel is used to mount the mounting plate of the rotating disc 5.

5: The use of purely LED lights 23 as the material for the lighting requirement of the billboard frame 22. This is specifically utilized as the entire automated rotating billboard structure is intentionally built to be environment-friendly. Said 50 watts LED lights 23 which were made up of die cast aluminium housing 30 and water resistant were attached in between the frames of the said billboard structure by bolting with the use 10 mmø grade A-36 steel bolt and nut.

6: The width of both the upper rotating post member 16 and the lower stationary post member 8 are projected to correspond to the measurement and load capacity requirements of the billboard frame 22 that will be mounted on them. This is precisely noted so as to assure the sturdiness of the entire structure. But the above post members must possess width measurement of at least 20-inch diameter for the upper rotating post member 16 and a 24-inch diameter for the lower stationary post member 8. These width measurements must be considered as the standard measurements respectively.

7: The non-limiting height of the upstanding post which is required as such in order to conform in accordance with the locational requirement where the structure shall be installed. The enhanced version shall have a minimum height of about 15 feet from the pedestal 20 up to as high as 60 feet from the pedestal 20. The abovementioned height range should correspond with the measurement and load capacity of the billboard frame 22 to assure safety of the structure. The anchor bolt 19 which is Grade A-36 steel, is used to connect the concrete pedestal 20 to the steel post. The said lower stationary post member 8 is attached to the concrete pedestal 20 by the use of Grade A-36 steel anchor bolt 19 connecting the base plate 10 of the lower stationary post member 8 and the concrete pedestal 20. Size of anchor bolts 19 varies from 25 mmø to 32 mmø in order to resist enough tension, bending and torque that the lower stationary post member transmits to the concrete pedestal 20 down to the foundation. Said foundation is designed using 6″ø G.I. pipes with inside concrete acting as piles 29 embedded 20′ to 30′ below the bottom of the footing to prevent any overturning condition that might occur due to large velocity winds during typhoon season, resulting in a typhoon resistant structure. The mounting plate which is made of 30-40 mm thick that is MS plate with Grade A36. The base plate 10 which is made of 25-30 mm thick that is MS plate with Grade A36. And the stiffener plate 9 that is used to stiffen the post against buckling and which is 10-12 mm thick that is MS plate with Grade A36.

8: This improved automated rotating billboard specifically claims that it is typhoon-resistant by virtue of its design using 6″ø G.I. pipes with inside concrete acting as piles 29 embedded 20′ to 30′ below the bottom of the footing to prevent any overturning condition that might occur due to large velocity winds during typhoon season resulting in a typhoon resistant structure. Significantly, the original model, which comprises the same heavy-duty features as that of the improved version, has withstand two (2) very strong typhoons which left majority of the typhoon-struck places in the Philippines dominantly sufferings from each of their wrath. Said structure remained solid and durable where it is installed. Hence, this improved automated rotating billboard shall likewise have the same, if not, even better capacity to withstand the strong typhoon.
